(19) United States
(12) Patent Application Publication
(10) Pub. No.: US 2023/0318064 A1
(43) Pub. Date: Oct. 5, 2023

(54) ACTIVE MATERIAL SEPARATION APPARATUS

(71) Applicant: HONDA MOTOR CO., LTD., Tokyo (JP)

(72) Inventor: Masafumi Saito, Tokyo (JP)

(21) Appl. No.: 18/127,027

(22) Filed: Mar. 28, 2023

(30) Foreign Application Priority Data
Mar. 31, 2022 (JP) 2022-059047

(51) Int. Cl. H01M 10/54

(52) U.S. Cl. CPC H01M 10/54

(57) ABSTRACT

An active material separation apparatus according to an embodiment of the present invention is an active material separation apparatus for separating an active material from a battery member, which includes a container, a base member that is disposed inside the container and that is configured to support the battery member, and a nozzle that is disposed above the container and that is configured to jet a fluid to the battery member, the base member being movable at least in a horizontal direction.

### CROSS-REFERENCE TO RELATED APPLICATION

Priority is claimed on Japanese Patent Application No. 2022-059047, filed Mar. 31, 2022, the content of which is incorporated herein by reference.

### BACKGROUND OF THE INVENTION

### Field of the Invention

The present invention relates to an active material separation apparatus.

### Description of Related Art

For the purpose of CO₂ reduction from the viewpoint of climate-related disasters, interest in electric vehicles is increasing, and the demand for batteries mounted on electric vehicles is also increasing. Under such circumstances, research on recycling of battery materials is underway. For example, research has focused on high efficiency recovery of a metal used as an active material of an electrode, cost reduction of a recovery process, and the like.

For example, PCT Internal Publication No. 2010/106618 discloses a battery member processing method including a positive electrode active material recovery process of recovering a positive electrode active material that is an insoluble element by bringing a battery member in contact with processing liquid containing water.

### SUMMARY OF THE INVENTION

In separation of an active material from an electrode, less damage to the active material is desirable.

In addition, in recycling of batteries in which the material has deteriorated and the capacity has decreased, it is common to separate the active material from the electrode, and to perform restore treatment with respect to the separated active material. In the recycling technique in the related art, when the active material is separated from the electrode, for example, roasting is performed at a temperature of 500° C. or more. However, in such a technique, energy consumption is considered to be large. For this reason, improvement of energy efficiency in recycling is required. When the energy efficiency is improved, recycling costs can be reduced.

An aspect of the present invention is directed to providing an active material separation apparatus capable of separating an active material while reducing processing costs and suppressing damage.

The aspects of the present invention is as follows.

[1] An active material separation apparatus according to an aspect of the present invention is an active material separation apparatus for separating an active material from a battery member containing the active material, which includes a container; a base member that is disposed inside the container and that is configured to support the battery member; and a nozzle that is disposed above the container and that is configured to jet a liquid to the battery member, the base member being movable at least in a horizontal direction.

[2] The active material separation apparatus according to the above-mentioned [1] may include a waste liquid part having an opening/closing valve is disposed below.

[3] In the active material separation apparatus according to the above-mentioned [1] or [2], the base member may be movable in a vertical direction.

[4] In the active material separation apparatus according to the above-mentioned [2], the waste liquid part may be disposed below the base member, a contact portion having a shape corresponding to a shape of a lower surface edge portion of the base member may be provided on an inner surface of the container, the base member may be movable in a vertical direction, and the inside of the container may be divided into a first space above the contact portion and a second space below the contact portion by bringing the lower surface edge portion of the base member in contact with the contact portion.

[5] The active material separation apparatus according to the above-mentioned [4] may include a second waste liquid part different from the waste liquid part that is a first waste liquid part.

[6] The active material separation apparatus according to any one of the above-mentioned [1] to [5] may include an annular inner lid portion provided inside the container.

[7] The active material separation apparatus according to any one of the above-mentioned [1] to [6] may include a collecting filter disposed inside the container.

According to the aspect of the present invention, it is possible to reduce processing costs and separate the active material with less damage.

In addition, according to the active material separation apparatus of the above-mentioned [2], scattering of the active material can be suppressed, and recovery efficiency of the active material can be increased.

In addition, according to the active material separation apparatus of the above-mentioned [3], it is possible to adjust a distance between the battery member and the nozzle and adjust collision energy of the jet body with the battery member in order to provide a simple configuration of the nozzle. Accordingly, apparatus costs can be reduced.

In addition, according to the active material separation apparatus of the above-mentioned [4], since the inside of the container is divided into the first space and the second space, even when the active material rises upon discharge of a liquid, the active material can be prevented from rising to the first space, and discharge of the active material from the second waste liquid part can be prevented. As a result, a decrease in recovery rate of the active material can be suppressed.

In addition, according to the active material separation apparatus of the above-mentioned [5], the liquid can be discharged from the first waste liquid part and the second waste liquid part, and a discharge speed of the liquid can be increased.

In addition, according to the active material separation apparatus of the above-mentioned [6], since the inner lid portion suppresses fluctuation of the liquid surface, the separated active material is prevented from being scattered and adhered to the lid or the inner side surface of the container. For this reason, recovery efficiency of the active material can be improved.

In addition, according to the active material separation apparatus of the above-mentioned [7], a recovery rate of the active material can be increased.

### BRIEF DESCRIPTION OF THE DRAWINGS

FIG. 1 is a view showing a schematic configuration of an active material separation apparatus according to an embodiment of the present invention.

FIG. 2 is a view along line II-II in FIG. 1.

FIG. 3 is a view showing a variant of the active material separation apparatus according to the embodiment along line II-II in FIG. 1.

### DETAILED DESCRIPTION OF THE INVENTION

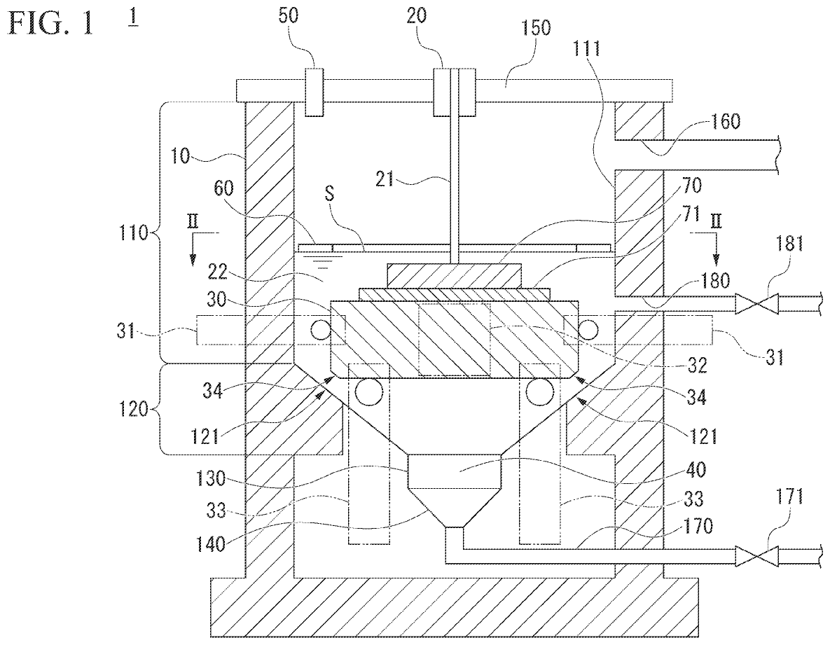

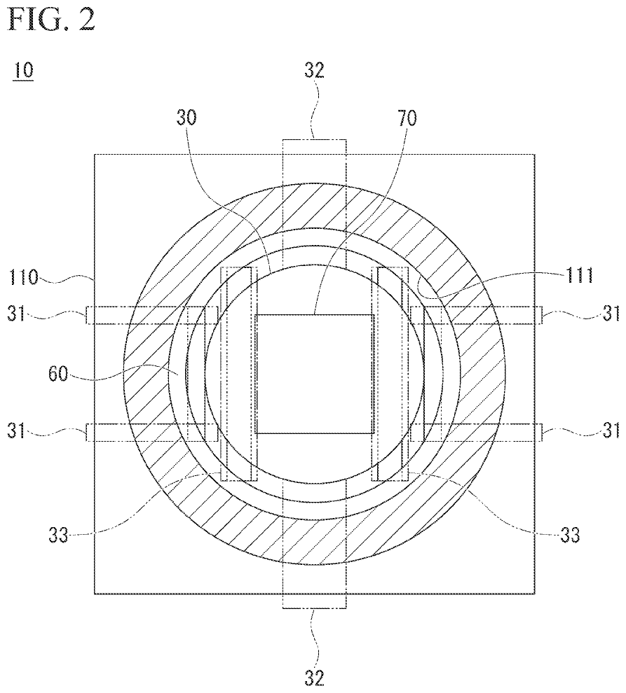

An active material separation apparatus according to an embodiment of the present invention will be described with reference to FIGS. 1 and 2. FIG. 1 is a view showing a schematic configuration of the active material separation apparatus according to the embodiment. FIG. 2 is a view along line II-II of FIG. 1. Further, in the specification and the drawings, components having substantially the same functional configurations are designated by the same reference signs and overlapping description will be omitted.

An active material separation apparatus 1 according to the embodiment is an apparatus for separating an active material from a battery member 70. The active material separation apparatus 1 includes a container 10, a nozzle 20 disposed above the container 10, a base member (table) 30 disposed in the container 10, a collecting filter 40 disposed in the container 10, a displacement gauge 50, and an inner lid portion 60.

The container 10 has a drum section 110 having an internal space with substantially the same diameter in a vertical direction, a first diameter reduction section 120 connected to the drum section 110 and having a diameter reduced downward as shown in FIG. 1, a collecting section 130 connected to the first diameter reduction section 120, a second diameter reduction section 140 connected to the collecting section 130 and having a diameter reduced downward, and a lid 150 disposed above the drum section 110 and configured to cover the inside of the container 10. In the first diameter reduction section 120 and the second diameter reduction section 140, an area of a horizontal cross section is reduced downward. The first diameter reduction section 120 has a contact portion 121 having a shape in the inner surface corresponding to a shape of a lower surface edge portion 34 of the table 30. The collecting filter 40 corresponding to the shape is disposed on the collecting section 130.

In addition, as shown in FIG. 1, the container 10 includes an exhaust port 160, a first waste liquid part 170, and a second waste liquid part 180.

The exhaust port 160 exhausts a jet body 21 jetted from the nozzle 20 by the battery member 70 or a gas generated by contacting a liquid 22 that constitutes the jet body 21 to the outside of the container 10. The exhaust port 160 is provided in the drum section 110, and the above mentioned gas can be easily discarded to the outside of the container 10.

The first waste liquid part 170 is a tubular member that is connected to a lower end of the second diameter reduction section 140 of the container 10. The liquid 22 of the container 10 flows downward together with the active material separated from the battery member 70. The active material is collected by the collecting filter 40, and the liquid 22 passes through the collecting filter 40 and is discharged to the outside of the container 10 through the first waste liquid part 170.

A first opening/closing valve 171 is provided in the first waste liquid part 170. When the jet body 21 is jetted in a state in which the first opening/closing valve 171 is closed, the liquid 22 is stored inside the container 10. By jetting the jet body 21 from the nozzle 20 to the battery member 70 in a state in which a liquid surface S of the stored liquid 22 is higher than a surface of the battery member 70, since collision energy in which the battery member 70 receives from the jet body 21 is reduced, damage to the active material can be further suppressed.

The second waste liquid part 180 is a tubular member connected to the inside of the container 10 from a side surface in the drum section 110 of the container 10. The liquid 22 stored in the container 10 is discharged to the outside of the container 10 through the second waste liquid part 180. For this reason, a discharge speed of the liquid 22 can be increased by discharging the liquid 22 from the first waste liquid part 170 and the second waste liquid part 180. In addition, the second waste liquid part 180 is connected to an inner side surface 111 of the drum section 110 and is provided at a higher position than the first diameter reduction section 120. For this reason, the active material contained in the liquid 22 discharged from the second waste liquid part 180 is small. Accordingly, in the container 10, discharge of the liquid 22 proceeds without reducing a recovery rate of the active material. In addition, a second opening/closing valve 181 is provided in the second waste liquid part 180. When the second opening/closing valve 181 is closed, a larger volume of the liquid 22 can be stored in the container 10.

The nozzle 20 configured to jet the jet body 21 is provided in the lid 150 of the container 10. The jet body 21 is jetted toward the battery member 70 by the nozzle 20.

The jet body 21 is a liquid that reacts with a solid electrolyte material contained in the battery member 70. As the jet body 21, for example, a protonic polar solvent may be exemplified, and specifically, water, ethanol, methanol, acetone, or the like may be exemplified. Further, a mixture thereof may be used as the jet body 21.

The liquid 22 is a liquid that constitutes the jet body 21 or a liquid stored in the container 10, the first waste liquid part 170, and the second waste liquid part 180 after collision of the jet body 21 with the battery member 70. The liquid 22 that has collided with the battery member 70 contains dissolved components of the battery member 70, in addition to components of the jet body 21.

When the battery member 70 is exposed from the liquid surface S of the liquid 22, the jet body 21 directly collides with the battery member 70. Meanwhile, when the upper surface of the battery member 70 is located below the liquid surface S, in other words, when the battery member 70 is submerged in the liquid 22, the jet body 21 collides with the battery member 70 while the collision energy thereof is reduced by the liquid 22. For this reason, scattering of the active material can be suppressed. As a result, recovery efficiency of the active material can be increased.

The table 30 supports the battery member 70. The table 30 moves at least in the horizontal direction. For example, as shown in FIGS. 1 and 2, the table 30 has a plurality of first shafts 31 extending in one direction in the horizontal surface, and a plurality of second shafts 32 perpendicular to the plurality of first shafts 31 in the horizontal surface. The table 30 moves in the axial direction as the first shafts 31 and the second shafts 32 each move in the axial direction thereof. Accordingly, the table 30 is movable in the horizontal direction.

In addition, as shown in FIG. 1, the table 30 has a plurality of third shafts 33 extending in the vertical direction. The third shafts 33 can move the table 30 in the vertical direction. It is possible to adjust a distance between the battery member 70 and the nozzle 20 and adjust collision energy of the jet body 21 with the battery member 70 by moving the battery member 70 in the vertical direction using the third shafts 33. As a result, the nozzle 20 can have a simple configuration. Accordingly, apparatus costs can be reduced.

In addition, each of the third shafts 33 is operable independently, and when only one of the third shafts 33 is raised or lowered, the table 30 is raised or lowered on the side of such third shaft 33. As a result, the table 30 is inclined in the horizontal direction. When the table 30 is not inclined, even after termination of the separation processing of the active material, the active material tends to remain on the surface of the table 30. When the active material remains on the surface of the table 30, it is difficult to stably dispose the battery member 70, which is a target of the next processing, on the table 30. For this reason, in order to remove the active material remaining on the table 30, while a washing process is performed with water or the like, the active material remaining on the table 30 can be easily removed by inclining the table 30.

As shown in FIG. 1, the lower surface edge portion 34 of the table 30 has a shape corresponding to the shape of the contact portion 121 in the first diameter reduction section 120. The table 30 is moved by the third shafts 33 in the vertical direction, the lower surface edge portion 34 of the table 30 comes in contact with the contact portion 121 of the first diameter reduction section 120, and thus, the inside of the container 10 is divided into a first space above the contact portion 121 and a second space below such contact portion.

When the liquid 22 remaining in the container 10 is discharged from the first waste liquid part 170 and the second waste liquid part 180, and the active material settled in the collecting filter 40 and the first diameter reduction section 120 may rise up in the liquid 22. In this case, the risen active material may be discharged from the second waste liquid part 180 to the outside together with the liquid 22. However, in a state in which the liquid 22 is stored in the container 10 and the active material is settled in the vicinity of the collecting filter 40 of the first diameter reduction section 120 and on the collecting filter 40, when the lower surface edge portion 34 of the table 30 comes into contact with the contact portion 121 of the first diameter reduction section 120 and the inside of the container 10 is divided into a first space and a second space, even in a case the active material rises upon discharge of the liquid 22, it is possible to prevent the active material from rising up till the first space and to prevent the active material from discharging from the second waste liquid part 180. As a result, it is possible to suppress reduction in recovery rate of the active material.

The displacement gauge 50 is an apparatus for measuring a height of the liquid surface S of the liquid 22 in the container 10, which is provided on the lid 150. The displacement gauge 50 is, for example, a laser displacement gage, which radiates a laser downward and measures a height of the liquid surface S.

The inner lid portion 60 is an annular member, is composed of a material having a density lower than that of the liquid 22, and can float on the liquid surface S. An appearance of the inner lid portion 60 is a shape corresponding to the inner side surface 111 of the drum section 110 when seen in a plan view, and an outer diameter of the inner lid portion 60 substantially coincides with an inner diameter in a horizontal surface of the drum section 110 of the container 10. In a state in which the inner lid portion 60 floats on the liquid surface S, when the separation processing of the active material is performed, since the inner lid portion 60 suppresses fluctuation of the liquid surface S, the separated active material is prevented from scattering together with the liquid 22 and adhering to the lid 150 or the inner side surface 111 of the container 10. Accordingly, since recovery of the active material adhered to the lid 150 or the inner side surface 111 is facilitated, recovery efficiency of the active material can be improved. In addition, when the battery member 70 contains, for example, a sulfide-based solid electrolyte and water is used for the jet body 21, while hydrogen sulfide reacting with the jet body 21 is generated through the separation processing, the generated hydrogen sulfide is easily dissolved in the liquid 22 by disposing the inner lid portion 60 on the liquid surface S. As a result, since the hydrogen sulfide dissolved in the liquid 22 is easily handled more than the hydrogen sulfide in a gaseous state, the hydrogen sulfide can be easily recovered.

In addition, the inner diameter of the inner lid portion 60 is greater than a maximum length of the battery member 70 in the horizontal direction. Since the inner diameter of the inner lid portion 60 is greater than the maximum length of the battery member 70 in the horizontal direction, attachment and detachment of the battery member 70 to/from the table 30 can be easily performed.

The battery member 70 is a processing target of the active material separation apparatus according to the embodiment. The battery member 70 contains, for example, a positive electrode active material having Li, and a solid electrolyte material. The battery member 70 may have at least one of the conducting material and the negative electrode active material.

The positive electrode active material is not particularly limited and contains, for example, Li. The positive electrode active material is usually not dissolved in the jet body 21 and the liquid 22. As the positive electrode active material, for example, a layered positive electrode active material, a spinel type positive electrode active material, an olivine type positive electrode active material, or the like, may be exemplified. As the layered positive electrode active material, for example, LiCoO₂, LiNiO₂, LiCo_{1/3}Ni_{1/3}Mn_{1/3}O₂, LiVO₂, LiCrO₂, or the like, may be exemplified. As the spinel type positive electrode active material, for example, LiMn₂O₄, LiCoMnO₄, Li₂NiMn₃O₈, LiNi_{0.5}Mn_{1.5}O₄, or the like, may be exemplified. As the olivine type positive electrode active material, for example, LiCoPO₄, LiMnPO₄, LiFePO₄, or the like, may be exemplified.

The solid electrolyte material contains an ingredient that is dissolved in the jet body 21 and the liquid 22. The solid electrolyte material contains, for example, Li and S. The solid electrolyte material preferably does not contain an ingredient that is not dissolved in the jet body 21 and the liquid 22. When the solid electrolyte material consists only ingredients that can be dissolved in the jet body 21 and the liquid 22, the separation processing of the insoluble element and the positive electrode active material is unnecessary, and recovery of the positive electrode active material is facilitated. As the solid electrolyte material containing Li and S, for example, a material Li, S and a third component may be exemplified. As the third component, for example, at least one or more selected from the group consisting of P, Ge, B, Si, I, Al, Ga and As may be exemplified. The sulfide solid electrolyte material may be compound containing Li₂S, and sulfide except Li₂S.

As the negative electrode active material, for example, a metal active material and a carbon active material may be exemplified. As the metal active material, for example, In, Al, Si, Sn, and the like, may be exemplified. As the carbon active material, for example, mesocarbon microbeads, highly oriented graphite, hard carbon, soft carbon, or the like, may be exemplified.

As the conducting material, for example, acetylene black, carbon fiber, or the like, may be exemplified.

In addition, the battery member 70 may have a current collecting foil 71. The current collecting foil 71 is, for example, an aluminum foil provided on the positive electrode of the battery member 70, or a copper foil provided on the negative electrode of the battery member 70.

So far, the active material separation apparatus 1 according to the embodiment will be described. Next, an example of a method of separating an active material from the battery member 70 using the active material separation apparatus 1 according to the embodiment will be described.

First, in a state in which the first opening/closing valve 171 and the second opening/closing valve 181 are closed, the battery member 70 is disposed on the upper surface of the table 30. Here, the table 30 is spaced apart from the first diameter reduction section 120 of the container 10. Specifically, the contact portion 121 in the first diameter reduction section 120 is spaced apart from the lower surface edge portion 34 of the table 30.

Next, the jet body 21 is jetted from the nozzle 20 toward the battery member 70. The solid electrolyte material of the battery member 70 is dissolved in the jet body 21, and the active material is separated from the battery member 70 by collision of the jet body 21 with the battery member 70. The table 30 is moved in the horizontal direction by the first shafts 31 and the second shafts 32, and a collision position of the jet body 21 in the battery member 70 is changed. The liquid 22 is stored in the container 10 and the position of the liquid surface S is increased while the jet body 21 is jetted. Meanwhile, the active material separated from the battery member 70 is precipitated on the collecting filter 40. During this time, the position of the liquid surface S is measured by the displacement gauge 50.

After the separation of the active material from the battery member 70 on the table 30 is terminated, jet of the jet body 21 from the nozzle 20 is stopped and leaves still. The precipitation of the active material advances through such leaving still.

After such leaving still, the table 30 is lowered to bring the contact portion 121 in the first diameter reduction section 120 in contact with the lower surface edge portion 34 in the table 30. Accordingly, the inside of the container 10 is divided into a first space below the contact portion 121 and a second space above the contact portion 121.

After that, the first opening/closing valve 171 and the second opening/closing valve 181 are opened, and the liquid 22 stored in the container 10 is discharged to the outside of the container 10. Here, the first waste liquid part 170 discharges the liquid 22 stored in the first space, and the second waste liquid part 180 discharges the liquid 22 stored in the second space. Accordingly, the active material is collected in the collecting filter 40.

According to the necessity, the table 30 is moved upward to release the contact between the contact portion 121 and the lower surface edge portion 34 in the table 30, and further, only one third shaft 33 of the third shafts 33 and 33 is operated to incline the table 30. After the table 30 is inclined, the jet body 21 is jetted from the nozzle 20 toward the table 30. Accordingly, the active material remaining on the table 30 is removed from the table 30, and the removed active material is collected in the collecting filter 40.

After termination of the separation processing of the active material from the one battery member 70, the table 30 is moved to an initial position, a battery member 70 that is newly processed is disposed on the table 30, and these operations are repeated. So far, an example of the method of separating the active material from the battery member 70 using the active material separation apparatus 1 according to the embodiment has been described.

As described above, the active material separation apparatus 1 includes the container 10, the base member (table) 30 disposed in the container 10 and configured to support the battery member 70, and the nozzle 20 disposed above the container 10 and configured to jet the jet body 21 to the battery member 70. The base member 30 is movable at least in the horizontal direction. The solid electrolyte material of the battery member 70 is dissolved by the jet body 21, and further, the active material is separated from the battery member 70 due to the collision of the jet body 21 with the battery member 70. The damage to the active material is increased when the active material is separated by mechanical processing such as polishing or the like, according to the embodiment, damage to the active material can be suppressed. Further, according to the embodiment, since no roasting at a high temperature is required, the energy efficiency in the separation processing is high. Further, since the table 30 is movable in the horizontal direction, the fixed type nozzle 20 can be used, and the apparatus costs can be suppressed. Therefore, according to the embodiment, the processing costs can be reduced and the damage can be suppressed to separate the active material.

In addition, since the first waste liquid part 170 has the first opening/closing valve 171, the liquid 22 can be stored in the container 10, and the battery member 70 can be immersed in the liquid 22. Since the active material is separated in a state in which the battery member 70 is immersed in the liquid 22, scattering of the active material can be suppressed. As a result, recovery efficiency of the active material can be increased.

In addition, since the table 30 is movable in the vertical direction, it is possible to adjust a distance between the battery member 70 and the nozzle 20 and to adjust collision energy of the jet body 21 with the battery member 70. Accordingly, there is no need to adjust a flow speed of the jet body using the nozzle 20. As a result, the nozzle 20 can be configured simply, and the apparatus costs can be reduced.

In addition, the table 30 is movable in the vertical direction, the first waste liquid part 170 is disposed below the table 30, the contact portion 121 having a shape corresponding to the shape of the lower surface edge portion 34 of the table 30 is provided on the inner surface of the container 10, the lower surface edge portion 34 of the table 30 comes into contact with the contact portion 121, and thus, the inside of the container 10 is divided into a first space above the contact portion 121 and a second space below the contact portion. Since the inside of the container 10 is divided into the first space and the second space, even when the active material is raised up in the liquid 22 upon discharge of the liquid 22, the active material can be prevented from rising up till the first space, and discharge of the active material from the second waste liquid part 180 can be prevented. As a result, a decrease in recovery rate of the active material can be suppressed.

In addition, since the second waste liquid part 180 different from the first waste liquid part 170 is provided, the liquid 22 in the container 10 can be discharged from the second waste liquid part 180 together with the first waste liquid part 170, and an discharge speed of the liquid 22 can be increased.

In addition, since the annular inner lid portion 60 disposed in the container 10 suppresses fluctuation of the liquid surface S, the separated active material is suppressed from being scattered and adhering to the lid 150 or the inner side surface 111 of the container 10. For this reason, recovery efficiency of the active material can be improved.

In addition, since the collecting filter 40 is disposed inside the container 10 and a distance to the collecting filter 40 from the position where the battery member 70 is disposed is short, recovery loss of the active material is reduced. Accordingly, a recovery rate of the active material can be improved.

Hereinabove, while the embodiment of the present invention has been described, the present invention is not limited thereto. The above is just an example, and anything that has substantially the same configuration as the technical concept disclosed in the claims of the present invention and exhibits the same effect is included in the technical scope of the present invention.

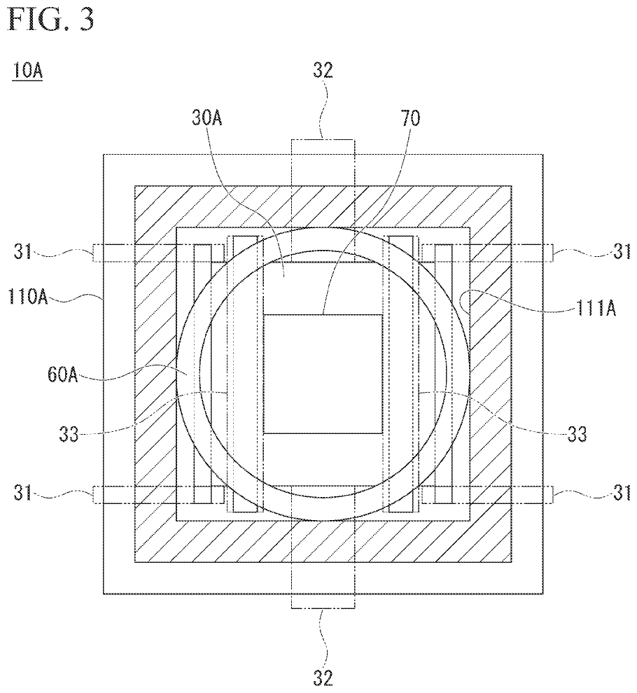

For example, in the above-mentioned embodiment, while the shape of the inner side surface 111 in the horizontal cross section of the drum section 110 is a circular shape, the shape of the inner side surface 111 in the horizontal cross section may not be the circular shape. For example, as shown in FIG. 3, the shape of the inner side surface 111A in the horizontal cross section of the drum section 110A may be a square shape. In this case, a shape of the horizontal cross section of the first diameter reduction section is also a square shape. Further, a shape of the horizontal cross section of the table 30A is also a rectangular shape. Then, a lower end portion of the table 30A comes into contact with the contact portion of the first diameter reduction section, and the inside of the container 10A is divided into the first space and the second space.

In addition, for example, in the above-mentioned embodiment, while the exhaust port 160 is provided on the drum section 110, it may be provided on the lid 150.

In addition, for example, a collecting filter (not shown) may be provided on the second waste liquid part 180. Even if the active material is flowed out to the second waste liquid part 180 by the collecting filter provided on the second waste liquid part 180, since the active material is collected by the collecting filter, reduction in recovery rate of the active material can be prevented.

In addition, the second waste liquid part is not limited to one, and a plurality of second waste liquid parts may be provided.

In addition, the nozzle is not limited to one, and a plurality of nozzles may be provided. According to the plurality of nozzles, the plurality of jet bodies can be jetted, and a separation speed of the active material can be increased. When the plurality of nozzles are provided, the disposition may be determined according to the size or the shape of the battery member.

In addition, the battery member is supported by the upper surface of the support member (not shown) smaller than the table, and the support member may be provided on the table. Disposition of the battery member on the table is facilitated by the support member.

In addition, the displacement gauge is not limited to one, and a plurality of displacement gages may be provided. When the plurality of displacement gages are provided, they may be provided along the inner side surface of the container at equal intervals. Since the plurality of displacement gages are provided along the inner side surface of the container, it is possible to reduce an influence on the fluctuation of the liquid surface by the jet body jetted from the nozzle. In addition, since the plurality of displacement gages are provided at equal intervals, it is possible to measure a position of the liquid surface more accurately.

In addition, in the above-mentioned embodiment, the appearance of the inner lid portion 60 is a shape corresponding to the shape of the inner side surface 111, and the appearance of the inner lid portion 60 substantially coincides with the diameter in the horizontal surface of the drum section 110. However, the appearance of the inner lid portion may not correspond to the shape of the inner side surface, and for example, as shown in FIG. 3, the shape of the inner side surface 111A of the drum section 110A is a quadrangular shape when seen in a plan view but the appearance of the inner lid portion 60A is a circular shape. In this way, the appearance of the inner lid portion may be different from the shape of the inner side surface of the drum section.

In addition, when the inner lid portion 60 is disposed, the displacement gauge 50 is preferably provided above the inner lid portion 60. Since the displacement gauge 50 is provided above the inner lid portion 60 and the displacement gauge 50 radiates a laser to the upper surface of the inner lid portion 60, it is possible to measure a position of the liquid surface S more stably.

The battery member is not limited to the above-mentioned materials, and the present invention can target the battery member containing various ingredients dissolved in the jet body.

In addition, at least the first opening/closing valve 171, the second waste liquid part 180, the third shafts 33, the collecting filter 40, and the inner lid portion 60 are arbitrary configurations, and may not be included in the active material separation apparatus according to the present invention. When the collecting filter 40 is not provided, the collecting filter may be provided outside the container 10, and the active material may be recovered by the collecting filter.

The above-mentioned configurations may be appropriately omitted or may be combined within a range in which the effects of the present invention are exhibited. In addition, the method of separating the active material from the battery member 70 is just an example, and as appropriate, an order of the processes may be changed or omitted within a practicable range.

What is claimed is:

1. An active material separation apparatus for separating an active material from a battery member containing the active material, the active material separation apparatus comprising:
a container;
a base member that is disposed inside the container and that is configured to support the battery member; and
a nozzle that is disposed above the container and that is configured to jet a liquid to the battery member,
wherein the base member is movable at least in a horizontal direction.

2. The active material separation apparatus according to claim 1, wherein a waste liquid part having an opening/closing valve is disposed below the container.

3. The active material separation apparatus according to claim 1, wherein the base member is movable in a vertical direction.

4. The active material separation apparatus according to claim 2, wherein the waste liquid part is disposed below the base member,
a contact portion having a shape corresponding to a shape of a lower surface edge portion of the base member is provided on an inner surface of the container,
the base member is movable in a vertical direction, and
the inside of the container is divided into a first space above the contact portion and a second space below the contact portion by bringing the lower surface edge portion of the base member in contact with the contact portion.

5. The active material separation apparatus according to claim 4, wherein a second waste liquid part different from the waste liquid part that is a first waste liquid part is provided.

6. The active material separation apparatus according to claim 1, wherein an annular inner lid portion is provided inside the container.

7. The active material separation apparatus according to claim 1, wherein a collecting filter disposed inside the container is provided.
